(19) United States
(12) Patent Application Publication
(10) Pub. No.: US 2007/0166049 A1
(43) Pub. Date: Jul. 19, 2007

(54) Laser vibrometer

(76) Inventors: Guy N. Pearson, Malvern (GB); David V. Willetts, Malvern (GB)

Correspondence Address: NIXON & VANDERHYE, PC, 901 NORTH GLEBE ROAD, 11TH FLOOR, ARLINGTON, VA, 22203, US

(21) Appl. No.: 10/589,499

(22) PCT Filed: Feb. 7, 2005
(86) PCT No.: PCT/GB05/00422

§ 371 Date: Aug. 15, 2006

(30) Foreign Application Priority Data
Feb. 17, 2004 (GB) 0403468.2

(51) Int. Cl. H04B 10/00

(52) U.S. Cl. 398/161

(57) ABSTRACT

This invention relates a laser vibrometer. A frequency modulated laser source (2, 3) generates a frequency modulated output, preferably a linear ramp, which is used for both the transmit beam and the local oscillator signal. Transmit (26) and receive optics (27) transmit the transmit beam towards a target and receive radiation returned therefrom. The local oscillator is mixed with the received beam and the mixed signal detected by a detector array (28). Before mixing with the received radiation however the local oscillator is delayed for a time substantially the same as the flight time of the radiation, preferably through a variable optical delay (32). Delaying the local oscillator signal in this way means that the received radiation was generated at nearly the same time as the local oscillator signal with which it was mixed and both received the same modulation. Therefore any variations in modulation of the modulation of the source will be present in both the receive beam and local oscillator signal and will to a large extent cancel. The use of a delay also means that the detected intermediate frequency has a narrow bandwidth easing signal processing requirements and also as the local oscillator signal is in near coincidence with the received beam the effects of phase noise of the source are reduced. The detected signal therefore has an intermediate component representative of residual range and bulk Doppler effects and an AC component which contains the microDoppler frequencies indicative of any vibrations of the target. The present invention therefore provides a 3D imaging vibrometer

This invention relates to a laser vibrometer, especially to a frequency modulated continuous wave imaging vibrometer and to an imaging laser vibrometer.

Laser vibrometry is a known technique for remote sensing of the vibration of a target, for instance laser microphones or non-contact testing equipment. Conventional systems illuminate a target with continuous wave radiation at a particular frequency and look for any frequency modulation on the return beam which contains information about the vibration of the target. It is also known to emit short laser pulses and look at the phase difference and time separation of radiation reflected from the target to determine the target vibration. This can require very fast and efficient detectors and fast processing.

Most vibrometry systems are non-imaging systems. However it is possible to scan single point vibrometers to build up a vibrometric image. Because of the relatively long acquisition time at each pixel such step-stare systems can take several minutes to build up an image. Also movement of the scanning receiver during the photon flight time can lead to lag angle problems in the vibrometric image.

An example of a known vibrometry system is described in P Lutzmann, R Frank, R Ebert and V Klein ‘Laser based vibration signatures of remote objects’ paper 22, NATO RTO Sensors and Electronics Technology Panel Symposium Complementarity of Ladar and Radar, Prague, Czech Republic, 22-23 Apr. 2002, Meeting Proceedings 92, 2003

It is therefore an object of the present invention to provide an improved laser vibrometer.

Thus according to the present invention there is provided a laser vibrometer comprising a frequency modulated continuous wave laser source producing a transmit beam and a local oscillator signal, means for directing the transmit beam to a scene and receiving radiation reflected from the scene and mixing means for mixing the received radiation with the local oscillator signal wherein the vibrometer further comprises an optical delay for delaying the local oscillator for substantially the flight time of the received radiation.

The present invention thus uses a continuous wave source which is frequency modulated and in which both the transmit beam and local oscillator (LO) have the same modulation. The use of a delay on local oscillator signal for substantially the flight time of the received radiation has several important advantages as will be described. Firstly it allows for slight errors in the frequency modulation to cancel in the received and local oscillator signals which reduces the need for extremely accurate frequency modulation (which is hard to achieve) whilst giving the required accuracy. Delaying the local oscillator also minimises the signal processing bandwidth requirements. When the received radiation is mixed with the local oscillator signal a moderate intermediate frequency is obtained which allows use of signal processing to take several samples of the signal over time to give precise vibrometric information. Thus the signal processing bandwidth is reduced to comfortable operating levels. The use of a delay also improves the phase noise of the apparatus.

The preferred frequency modulation applied to the source comprise linear frequency ramps, i.e. the frequency varies linearly with time during the sweep. Linear ramps offer the easiest processing of the detected signal. Using a linear ramp means that for a stationary target the received signal will be identical in frequency characteristics to the local oscillator signal but the frequency of the two signals will differ by an amount depending upon the flight time of the emitted radiation and the delay applied to the LO signal. Thus the resulting intermediate frequency remains constant for much of the return. If the target is moving along the sight-line this will introduce a constant bulk Doppler shift to the transmitted beam which will be reflected in a change of intermediate frequency. Finally any vibration of the target will impose micro-Doppler shifts on the returned radiation.

By delaying the local oscillator signal by a time substantially equal to the flight time of radiation the frequency shifting effect of the time of flight can be predominantly removed. Thus the intermediate frequency has a narrow bandwidth and the micro-Doppler information can be more readily obtained.

The frequency stability of the applied modulation, i.e. the linearity of the sweep in a linearly ramped system, is key to operating a frequency modulated continuous wave laser vibrometer and obtaining useful micro-Doppler information. To be able to extract the necessary information from the signal return both the transmit, and hence receive beam, and local oscillator signal need to show the same modulation. Most frequency modulated continuous wave sources however inevitably have some frequency variation from the desired modulation—frequency wander. Because of this frequency wander in modulation frequency, modulated continuous wave laser sources would previously have been thought as unsuitable for use in vibrometry. In the apparatus according to the present invention the same source is used for the transmit beam and local oscillator and both are modulated. Any fluctuations in frequency away from the intended modulation can lead to errors in the intermediate frequency. However as the local oscillator is delayed for substantially the round trip time of flight of the received radiation the received signal is mixed with a local oscillator signal that was generated at close to the same time. Therefore any frequency wander on the transmitted, and hence received, beam will also be present to some degree on the local oscillator signal and hence will, to a large extent, cancel in the intermediate frequency. This allows the use of frequency modulated sources which have a degree of modulation variation, i.e. ramp non-linearity to be used and still provide accurate vibrometric information. In effect it relaxes the requirement for absolute frequency stability of the modulation.

Laser sources also experience variations in phase, so called phase noise. Again a difference in phase noise between the received beam and the local oscillator signal can lead to errors in the detected signal. Use of a delay for substantially the flight time of the radiation again means that the local oscillator signal is brought into near coincidence with the received radiation which substantially cancels any phase noise variation.

Preferably the optical delay is a variable optical delay. The advantages of delaying the local oscillator by substantially the flight time of the transmitted radiation rely on knowing what that flight time is. Generally this will not be known prior to use and hence a variable delay is needed. Various variable optical delays are known and could be used in the present invention, for instance variable fibre optic delay lines.

The optical delay may delay the local oscillator signal for a period of time equal or nearly equal to the flight time of the transmitted and received radiation. The delay may also be adjusted to account for any bulk Doppler effects. As mentioned for a target with no bulk motion along the sight-line there will be no bulk Doppler and delaying the local oscillator signal by exactly the same time as the round trip time of the emitted radiation will result in the local oscillator signal and received radiation having exactly the same frequency. This would result in there being no intermediate frequency other than as a result of any frequency shifts generated by micro-Doppler effects. In practice it may be preferable to ensure that there is a low intermediate frequency present at all times so the delay may not exactly match the flight time of the radiation. This leads to a narrow bandwidth intermediate frequency with detectable micro-Doppler effects.

Where a target does have bulk motion the bulk Doppler will, as mentioned, change the frequency of the received signal by a constant amount. The delay applied to the local oscillator may compensate for any bulk Doppler effects again to leave a low, constant intermediate frequency which exhibits any micro-Doppler effects.

The range information and bulk Doppler information may be determined separately by a separate ranging/Doppler apparatus, which may be integral with the vibrometer of the present invention. The skilled person would be well aware of conventional equipment which could be used to provide range information to a target and the bulk Doppler thereof. The ranger could be a single pixel device.

Alternatively the present invention may be adapted to be operable in two modes, a first mode wherein bulk range and Doppler information is acquired and a second mode where the vibrometric image data is acquired, the data from the first mode being used to set the required delay for the second mode of operation. For instance the source could be arranged to transmit a beam as usual but the LO signal not delayed. As mentioned above the frequency difference between the LO signal and received beam will depend on the time of flight, and hence range to target, of the received radiation and the speed, hence bulk Doppler, of the target. The intermediate frequency received therefore gives range and bulk Doppler information which can be used to set an appropriate delay for the vibrometric imaging step.

It should be noted that in some applications it will not be necessary to determine the actual range and bulk Doppler contributions separately—the combined effect will still allow one to set the appropriate delay and all that might be required is the vibrometric image.

As mentioned the stability of the laser source is an important consideration for frequency modulated continuous wave operation. Preferably therefore the source is a frequency stabilised source. The source may therefore comprise a frequency stabilisation means. Preferably the frequency stabilisation means comprises means for identifying errors in the modulation and a modulator for correcting for said identified errors. Preferably a portion of the output of the laser is fed into the means for identifying errors in the modulation and a portion of the output is fed into an optical delay. By delaying one portion of the output of the laser source the other portion can be analysed, for instance through heterodyning with a reference laser, to identify any errors and then these errors can feedback to the modulator acting on the delayed radiation. This allows time for any errors, i.e. ramp non-linearites to be identified and corrected. Another technique that could be applied in phase sensitive detection.

Preferably the means for directing the transmit beam to a scene and receiving radiation reflected from the scene transmits and receives radiation from a plurality of look directions. In other words the vibrometer is a multi-pixel vibrometer which provides simultaneous vibrometric information from a plurality of positions in the scene. Conveniently the transmitted beams may be arranged to form a 2D array. The number of pixels may be greater than 1000. Thus the vibrometer can give range information and vibrational signature at each element in the array to provide a 3D vibrometric image. This avoids the need for scanning mechanisms.

The array of transmit beams may be created using a one to many beamsplitter, for instance a multimode interference (MMI) beamsplitter or through use of a microlens array etc. The skilled person would be aware of methods of generating the array of transmit beams and also collecting the received radiation.

The laser vibrometer may be arranged to be bistatic, i.e. separate transmit and receive optics, or monostatic, i.e. the same optics transmit and receive.

The detector is preferably a detector array, for instance an avalanche photo-detector array.

The laser source preferably has a wide bandwidth frequency modulation. The range resolution achievable by the vibrometer depends upon the bandwidth of the modulation, or chirp, applied. A bandwidth of approximately 1 GHz or more may be appropriate.

Preferably the modulation ramp time is fast, i.e. the time taken to sweep through the entire frequency range. As will be explained later to separate microDoppler returns from frequency shifts due to range the ramp time should be equal to or less than the inverse of greatest microDoppler shift expected. In fact the ramp time should be shorter than any coherence time of the expected returns. For most cases of interest the microDoppler will have the shortest coherence time and therefore will the limiting factor on setting ramp time. However certain fast moving targets may therefore not be appropriate to be imaged using the present invention. Conveniently the ramp time may be 10 μs of less.

The laser source is preferably eye safe and may operate in the 1.5 μm eye safe wavelength band.

According to a second aspect of the present invention there is provided a method of obtaining vibrometric data from a target comprising the steps of;
i) forming a transmit beam and a local oscillator signal from a frequency modulated continuous wave laser source,
ii) transmitting the transmit beam to a scene and receiving any radiation returned from the scene
iii) delaying the local oscillator for substantially the flight time of the received radiation, and
iv) mixing the received radiation with the delayed local oscillator signal and detecting the frequency of the mixed signal.

The method of the second aspect of the present invention has all of the same advantages and can be implemented in the same manner as the invention of the first aspect of the present invention. The method may comprise the initial step of determining bulk range and Doppler information from the scene and using the range and Doppler information to set the delay on the local oscillator signal. This may be done using a separate ranger or by performing a first range and Doppler measurement followed by a vibrometer measurement. The method may comprise the step of processing the mixed signal to determine differential range and microDoppler information.

The invention will now be described by way of example only with reference to the following drawings of which;

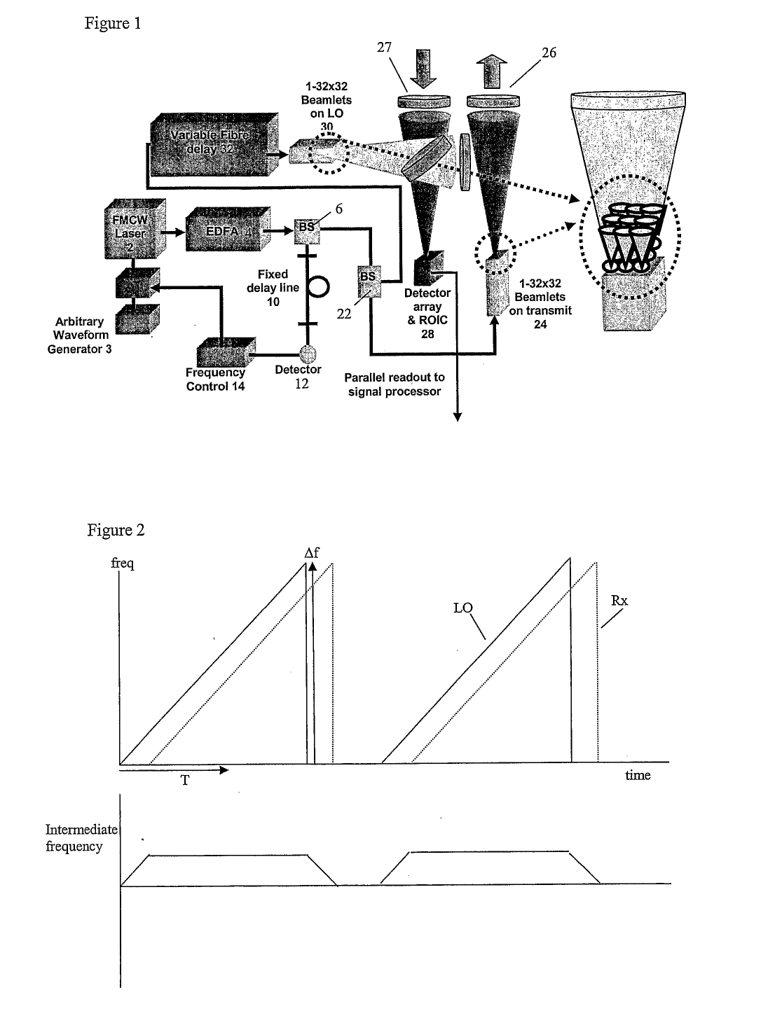

FIG. 1 shows a schematic of the laser vibrometer of the present invention,

FIG. 2 shows the frequency modulation applied,

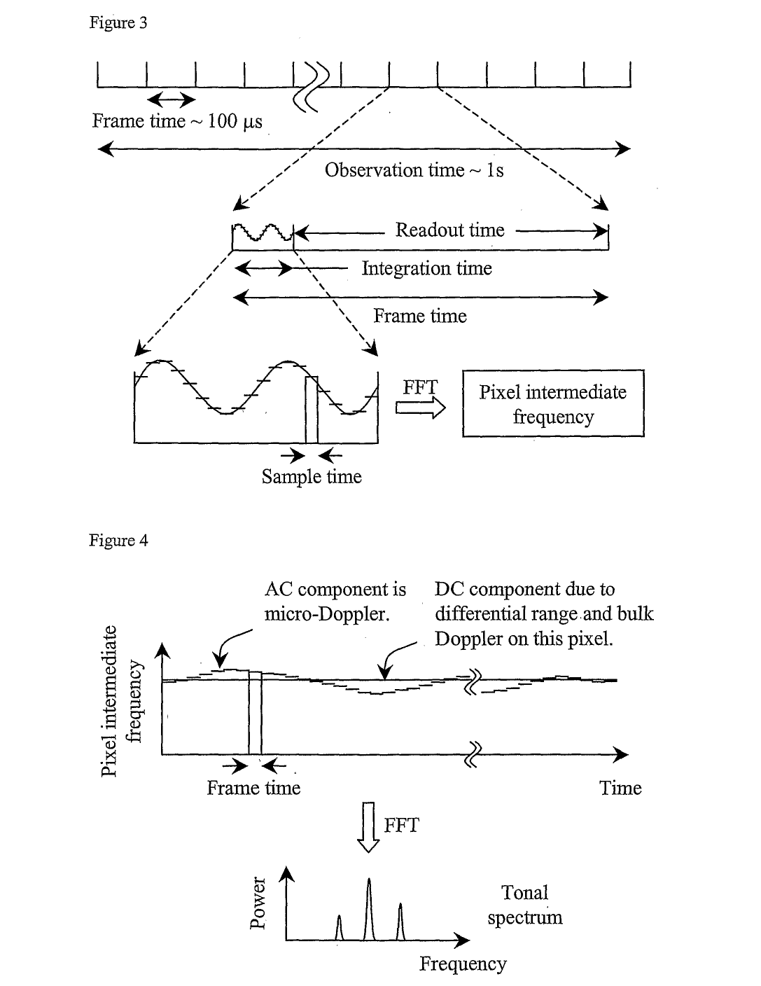

FIG. 3 shows a pixel readout timing, and

FIG. 4 shows the conversion of microDoppler history information into a tonal spectrum.

Referring to FIG. 1 a laser vibrometer of the present invention is shown. A frequency modulated continuous wave (FMCW) laser source 2, driven by waveform generator 3 illuminates erbium doped fibre amplifier 4 to generate an output signal which is frequency modulated by a succession of linear frequency ramps such as shown in FIG. 2. The laser output is eye safe, falling with the 1.5 μm eye safe bands. The skilled person would be aware of various methods of frequency modulating laser sources which would be applicable.

The laser output is then incident on beamsplitter 6 which directs part of the output to a feedback frequency stabilisation control. The frequency stabilisation control uses a delay line 10 and detector 12 and detects any non-linearity by phase sensitive detection as will be understood by one skilled in the art. Where any non-linearity is detected an appropriate correction is made via frequency control unit 14 to the waveform generator 3 so as to give as stable a linear output as possible.

The modulated signal is then divided into a transmit beam and a local oscillator by beamsplitter 22. Both the transmit beam and the local oscillator signal therefore share exactly the same frequency modulation.

The transmit beam is then divided into a 32 by 32 array of beamlets using a 1-32×32 MMI splitter 24. MMI (or multimode interference) splitters are known in the art for exactly replicating an input beam of radiation into a plurality of identical beamlets, for instance as described in U.S. Pat. No. 5,410,625. However other optical devices for forming a plurality of identical beamlets could be used, such as microlens arrays. The projected array is then directed toward the scene through optics 26.

Radiation received from the scene by receive optics 27 is imaged onto detector array 28. Detector array 28 is an array of avalanche photodiodes with integrated read-out circuitry with a high sampling rate.

The local oscillator signal is re-imaged onto the detector array using an exactly analogous 2D MMI beamsplitter 30 as is used to form the transmit beamlets. However the local oscillator signal is passed through variable optical delay 32 before being mixed with the receive beam. Variable optical delay 32 comprises an optical fibre delay with a variable switchable path length and is capable of providing delays for the expected ranges of operation which can vary from metres to kilometres.

As mentioned above the FMCW laser produces a frequency output that has a series of fixed duration ramps applied. FIG. 2 shows one possible arrangement. The solid line shows the LO signal which is identical to the transmitted beam. However other arrangements such as fixed up and down ramps are possible.

For a stationary target the received waveform is identical to the transmitted beam, and hence the LO signal but delayed by a time equal to the round trip transit time. Were no delay to be applied to the local oscillator this would result in an intermediate frequency which, as shown, is largely constant for most of the return with the frequency proportional to range. For targets having bulk sight-line motion the intermediate frequency would be changed by the appropriate Doppler shift. The range resolution is set by the total frequency excursion applied to the transmission and for the system described above a chirp of approximately 1 GHz will give a range resolution of about 15 cm. In other words if the frequency ramp has a bandwidth of 1 GHz then ranges to a resolution of 15 cm can be determined. The use of a wide bandwidth chirp allows good range resolution but would generally lead to a high signal processing bandwidth requirement for the detector array. However the present invention introduces a delay into the local oscillator signal which compensates for the time of flight and bulk Doppler shifts. This gives a moderate intermediate frequency and relaxes signal processing requirements to an acceptable level.

The delay required may be determined by a separate range and bulk Doppler sensor (not shown) which could be arranged integral with the vibrometric imager of the present invention. The data from this separate sensor can then be used to set an appropriate delay on the variable delay 32.

Alternatively the apparatus may be adapted to acquire range and bulk Doppler information about a target in a first step and then use this information to set the required delay and perform a vibrometric imaging step.

By introducing an appropriate delay into the local oscillator signal via variable delay 32 the intermediate frequency can be reduced to a narrow bandwidth which encompasses the microDoppler components in the received signal arising from vibration of the target. These microDoppler frequencies are low enough that they can be sampled at relatively slow speed. A slow sampling speed does mean a relatively long transmission time which itself means for peak power limited emission the signal strength is raised to useful levels.

It is necessary that the system be able to separate microDoppler frequency shifts from target vibration from frequency shifts due to range in adjacent range cells in the same sight-line.

As mentioned above range resolution depends upon the bandwidth of the chirp applied. Generally the ramp time must be less than the inverse of the maximum expected microDoppler frequency. For microDoppler frequencies of up to say 200 KHz at a wavelength of 1.55 μm this would result in a ramp time of about 5-15 μs. Taking a ramp time of 10 μs for a 1 GHz sweep would result in a frequency sweep rate of about 10¹⁴ Hz, which is achievable by current frequency tuneable semiconductor lasers.

A microDoppler frequency of approximately 200 KHz can be read out at a sample rate of about 500 KHz using the Nyquist criterion. A sample rate of 1 MHz is used and 10 samples can be read out to give an instantaneous measure of microDoppler frequency. However to establish the time history of the vibration it is necessary to take several successive samples. This is illustrated with respect to FIG. 3.

A series of samples are taken at a clock rate of approximately 1 MHz, each sample being acquired in a sample time. These are read-out and Fourier transformed in a frame time to give a pixel intermediate frequency, i.e. the microDoppler. A series of frames are recorded in an observation time of about 1 s.

As shown in FIG. 4 the microDoppler this will result in a series of readings having an AC component due to the microDoppler and a DC component due to the residual range and bulk Doppler. The frequency history of the pixel can then be Fourier transformed to reveal the characteristic frequencies, or tonals, at which that point on the surface is vibrating. This process is applied to every pixel in the array allowing a vibrometric image of the target surface to be produced. Alternatively the vibration amplitude associated with each tonal may be obtained from its power spectral density and characteristic frequency and similarly displayed. For instance a particular tonal frequency could be chosen and a two dimensional picture displayed of the target colour coded by vibration amplitude.

As shown in FIG. 4 the DC component of the intermediate frequency is due to the residual range and any uncompensated bulk Doppler on the pixel. In other words if the variable delay applied to each pixel equates to a range of say 1 km the DC component of the intermediate frequency will give the additional range of the that particular pixel, say 5 m. Thus each pixel will have range information about the pixel relative to the effective baseline set by the appropriate delay.

Each pixel may contain more than one intermediate frequency, for example where a target is behind a tree or some other partly obscuring cover there may be a return from the foliage and also the target. The present system is range gated however in that return from the foliage will be at one range and therefore will give one intermediate frequency whereas the target will be at a different range and hence will generate a different intermediate frequency. These two separate frequencies, each encoded with any relevant microDoppler information will be separately resolvable in different frequency bins applied to the pixel return. Thus the present invention allows a full 3D vibrometric image of a scene to be captured.

The use of a FMCW approach in the present invention with a wide bandwidth chirp applied to both the transmit beam and the local oscillator therefore allows good range information to be obtained about a target in two dimensions. The use of a variable delay adjusted to offset most range and bulk Doppler effects relaxes the linearity requirements of the FMCW source and allows any frequency variations in modulation to cancel. It also gives a narrow bandwidth intermediate frequency allowing the microDoppler frequencies to be captured in relatively slow time and mitigates the effects of phase noise of the source. Thus a three dimensional vibrometric image can be produced with good resolution and without the need for scanning, although the invention is applicable to step-stare scanned systems and single pixel systems.

Prior to the present invention the skilled person would not have thought that FMCW would be applicable to an imaging vibrometer due to ramp non-linearity of the source, bandwidth constraints and also phase noise. However using a frequency stabilised source removes most ramp non-linearity and delaying the LO so that it is mixed with the transmit beam produced at substantially the same time means any residual fluctuations tend to cancel each other out.

1. A laser vibrometer comprising a frequency modulated laser source for producing a transmit beam and a local oscillator signal, both having the same frequency modulation, means for directing the transmit beam to a scene and receiving radiation reflected from the scene and mixing means for mixing the received radiation with the local oscillator signal and a detector for detecting frequency variations between the received and local oscillator signals wherein the vibrometer further comprises an optical delay for delaying the local oscillator for substantially the flight time of the received radiation.

2. A laser vibrometer as claimed in claim 1 wherein the frequency modulation of] laser source comprises linear frequency ramps.

3. A laser vibrometer as claimed in claim 1 wherein the optical delay is a variable delay.

4. A laser vibrometer as claimed in claim 3 wherein the variable delay is a variable fibre optic delay line.

5. A laser vibrometer as claimed in claim 1 wherein the delay applied by the delay means compensates for any bulk Doppler effects.

6. A laser vibrometer as claimed in claim 1 wherein the delay is determined by a separate ranging/Doppler sensor.

7. A laser vibrometer as claimed in claim 6 wherein the ranging/Doppler sensor is integral with the vibrometer.

8. A laser vibrometer as claimed in any of claim 1 wherein the vibrometer is adapted to be operable in two modes, a first mode where bulk range and Doppler information is obtained and a second mode where the vibrometric image data is acquired, the data from the first mode being used to set the required delay for the second mode of operation.

9. A laser vibrometer as claimed in claim 1 wherein the comprises a frequency stabilisation means.

10. A laser vibrometer as claimed in claim 9 wherein the frequency stabilisation means comprises means for identifying errors in the modulation and a modulator for correcting for said identified errors.

11. A laser vibrometer as claimed in claim 10 wherein the output of the source is split into two portions, one portion being fed into an optical delay and another portion being fed into the means for identifying errors.

12. A laser vibrometer as claimed in claim 1 wherein the means for directing the transmit beam to a scene and receiving radiation reflected from the scene transmits and receives radiation from a plurality of look directions.

13. A laser vibrometer as claimed in claim 1 wherein the laser source has a wide bandwidth frequency modulation.

14. A laser vibrometer as claimed in claim 13 wherein the frequency modulation has a bandwidth of at least 1 GHz.

15. A laser vibrometer as claimed in claim 1 wherein the frequency modulation has a fast ramp time

16. A laser vibrometer as claimed in claim 15 wherein the ramp time is 10 μs of less.

17. A method of obtaining vibrometric data from a target comprising the steps of;
i) forming a transmit beam and a local oscillator signal from a frequency modulated continuous wave laser source,
ii) transmitting the transmit beam to a scene and receiving any radiation returned from the scene
iii) delaying the local oscillator for substantially the flight time of the received radiation, and
iv) mixing the received radiation with the delayed local oscillator signal and detecting the frequency of the mixed signal.

18. A method as claimed in claim 17 comprising the initial step of determining bulk range and Doppler information from the scene and using the range and Doppler information to set the delay on the local oscillator signal.

19. A method as claimed in claim 19 wherein the method comprises the step of processing the mixed signal to determine differential range and microDoppler information.
